(19) United States
(12) Patent Application Publication
(10) Pub. No.: US 2026/0046172 A1
(43) Pub. Date: Feb. 12, 2026

(54) SPATIAL DENOISING IN AI-ASSISTED CHANNEL ESTIMATION

(71) Applicant: Samsung Electronics Co., Ltd., Suwon-si (KR)

(72) Inventors: Yeqing Hu, Allen, TX (US); Yang Li, Plano, TX (US); Thuy Van Nguyen, Plano, TX (US)

(21) Appl. No.: 19/193,891

(22) Filed: Apr. 29, 2025

Related U.S. Application Data
(60) Provisional application No. 63/680,982, filed on Aug. 8, 2024.

(51) Int. Cl. H04L 25/02; H04B 17/309; H04L 5/00; H04W 28/06

(52) U.S. Cl. CPC H04L 25/0224; H04B 17/346; H04L 5/0051; H04W 28/06

(57) ABSTRACT

Methods and apparatuses for a spatial denoising in AI-assisted channel estimation in wireless communication systems are provided. The methods of BS comprise: receiving, from a UE, an SRS for a channel estimation operation; performing, based on the SRS, a frequency domain filtering operation; identifying, based on the frequency domain filtering operation, at least one set of antenna spatial bases or kernels; estimating, based on the at least one set of the antenna spatial bases, a spatial domain channel component; compressing, based on the estimated spatial domain channel component, a channel into a low-dimension domain or a sparse domain, wherein the channel is identified in a dimension; performing, based on the compressed channel, an SNR scaling operation for different kernels in the at least one set of kernels; and decompressing, based on the SNR scaling operation, the compressed channel into the dimension for the channel estimation operation.

### CROSS-REFERENCE TO RELATED APPLICATIONS AND CLAIM OF PRIORITY

The present application claims priority to U.S. Provisional Patent Application No. 63/680,982, filed on Aug. 8, 2024. The contents of the above-identified patent documents are incorporated herein by reference.

### TECHNICAL FIELD

The present disclosure relates generally to wireless communication systems and, more specifically, the present disclosure relates to a spatial denoising in artificial intelligence (AI)-assisted channel estimation in wireless communication systems.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a spatial denoising in AI-assisted channel estimation in wireless communication systems.

In one embodiment, a base station (BS) in a wireless communication system is provided. The BS comprises: a transceiver configured to receive, from a user equipment (UE), a sounding reference signal (SRS) for a channel estimation operation. The BS further comprises a processor operably couped to the transceiver, the processor configured to: perform, based on the SRS, a frequency domain filtering operation; identify, based on the frequency domain filtering operation, at least one set of antenna spatial bases or kernels; estimate, based on the at least one set of the antenna spatial bases, a spatial domain channel component; compress, based on the estimated spatial domain channel component, a channel into a low-dimension domain or a sparse domain, wherein the channel is identified in a dimension; perform, based on the compressed channel, a signal-to-noise ratio (SNR) scaling operation for different kernels in the at least one set of kernels; and decompress, based on the SNR scaling operation, the compressed channel into the dimension for the channel estimation operation.

In another embodiment, a method of a BS in a wireless communication system is provided. The method comprises: receiving, from a UE, an SRS for a channel estimation operation; performing, based on the SRS, a frequency domain filtering operation; identifying, based on the frequency domain filtering operation, at least one set of antenna spatial bases or kernels; estimating, based on the at least one set of the antenna spatial bases, a spatial domain channel component; compressing, based on the estimated spatial domain channel component, a channel into a low-dimension domain or a sparse domain, wherein the channel is identified in a dimension; performing, based on the compressed channel, an SNR scaling operation for different kernels in the at least one set of kernels; and decompressing, based on the SNR scaling operation, the compressed channel into the dimension for the channel estimation operation.

In yet another embodiment, a non-transitory computer-readable medium comprising program code is provided. The non-transitory computer-readable medium comprising program code, that when executed by at least one processor, causes an electronic device to: receive, from a UE, an SRS for a channel estimation operation; perform, based on the SRS, a frequency domain filtering operation; identify, based on the frequency domain filtering operation, at least one set of antenna spatial bases or kernels; estimate, based on the at least one set of the antenna spatial bases, a spatial domain channel component; compress, based on the estimated spatial domain channel component, a channel into a low-dimension domain or a sparse domain, wherein the channel is identified in a dimension; perform, based on the compressed channel, a signal-to-noise ratio (SNR) scaling operation for different kernels in the at least one set of kernels; and decompress, based on the SNR scaling operation, the compressed channel into the dimension for the channel estimation operation.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to various embodiments of the present disclosure;

FIG. 2 illustrates an example of gNB according to various embodiments of the present disclosure;

FIG. 3 illustrates an example of UE according to various embodiments of the present disclosure;

FIGS. 4 and 5 illustrate example of wireless transmit and receive paths according to various embodiments of the present disclosure;

FIG. 6 illustrates an example of antenna structure according to various embodiments of the present disclosure;

FIG. 7 illustrates an example of channel estimation procedure according to various embodiments of the present disclosure;

FIG. 8 illustrates an example of filter-based channel estimation procedure according to various embodiments of the present disclosure;

FIG. 9 illustrates another example of filter-based channel estimation procedure according to various embodiments of the present disclosure; and

FIG. 10 illustrates a flowchart of BS method for a spatial denoising in AI-assisted channel estimation according to various embodiments of the present disclosure.

### DETAILED DESCRIPTION

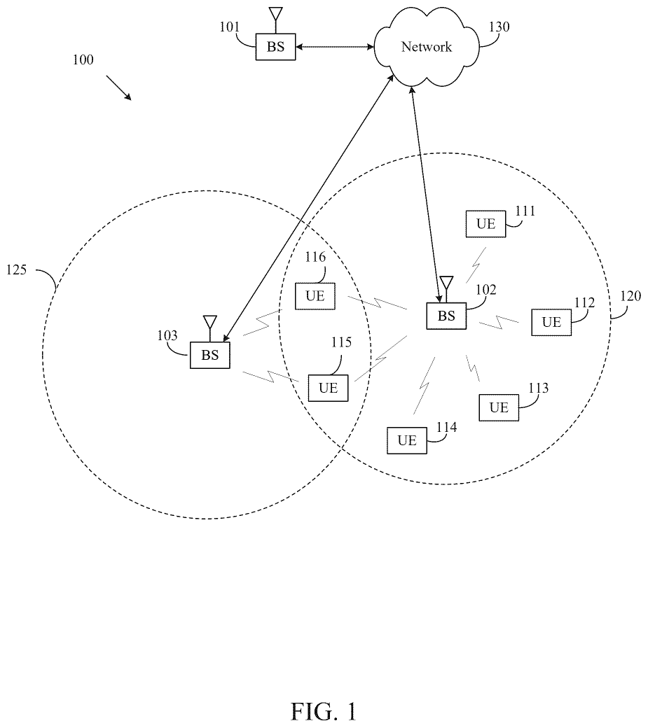

FIG. 1 through FIG. 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to various embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to generate signal/information for supporting a spatial denoising in AI-assisted channel estimation, at the gNB, in wireless communication systems. In certain embodiments, and one or more of the gNBs 101-103 includes circuitry, programing, or a combination thereof, to support a spatial denoising in AI-assisted channel estimation in wireless communication systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

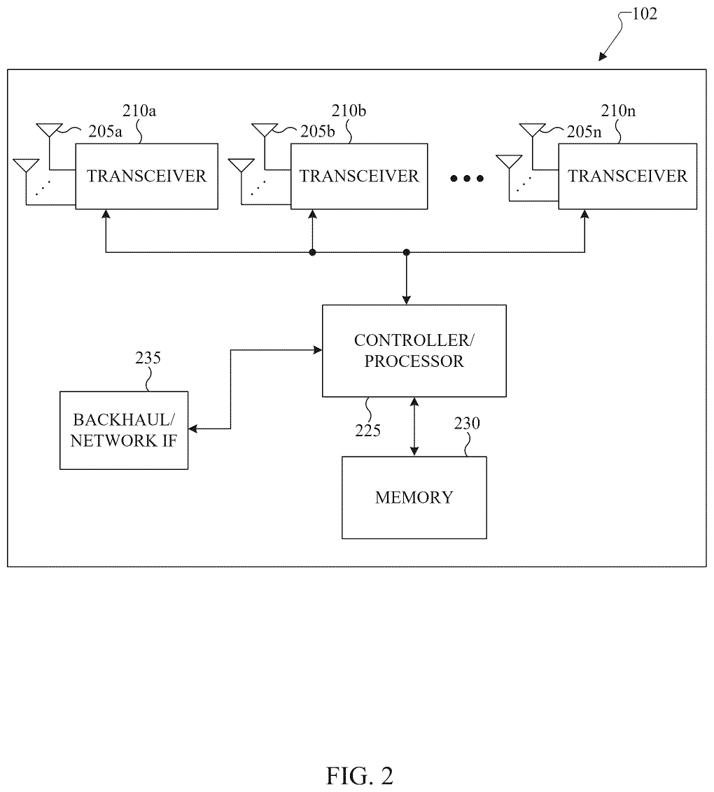

FIG. 2 illustrates an example gNB 102 according to various embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes to support a spatial denoising in AI-assisted channel estimation in wireless communication systems. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a wireless communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

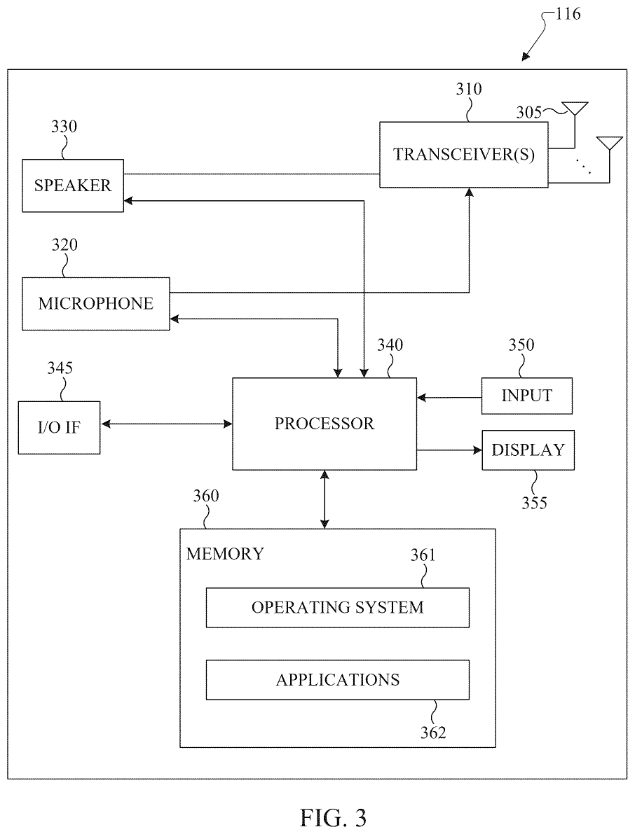

FIG. 3 illustrates an example UE 116 according to various embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes to generate information or signal for supporting a spatial denoising in AI-assisted channel estimation, at the gNB (e.g., 101-103 as illustrated in FIG. 1), in wireless communication systems.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

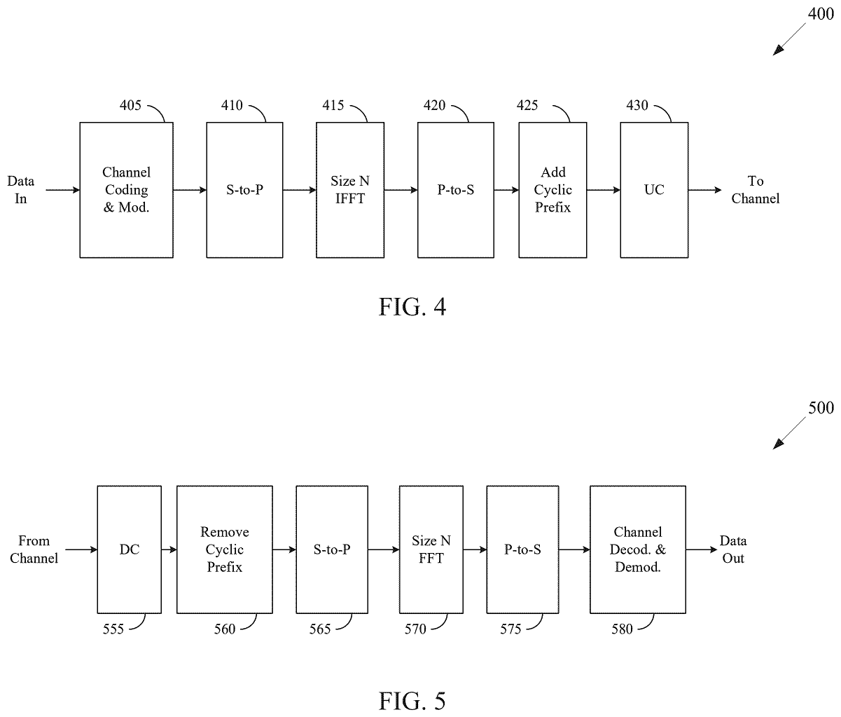

FIG. 4 and FIG. 5 illustrate example wireless transmit and receive paths according to various embodiments of the present disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a TCI state of a CORESET where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process comprises NZP CSI-RS and CSI-IM resources. A UE can determine CSI-RS transmission parameters through DL control signaling or higher layer signaling, such as a radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a MIMO transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

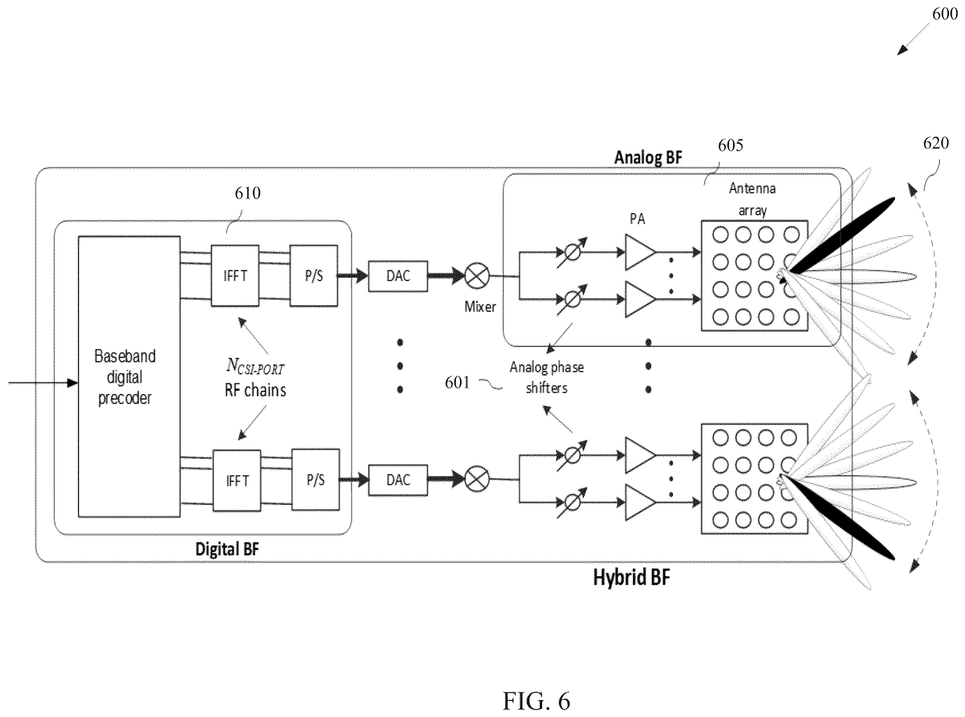

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 6.

FIG. 6 illustrates an example antenna structure 600 according to various embodiments of the present disclosure. An embodiment of the antenna structure 600 shown in FIG. 6 is for illustration only.

In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting,” respectively), and receiving a DL or UL transmission via a selection of a corresponding RX beam.

The aforementioned system is also applicable to higher frequency bands such as >52.6 GHz. In this case, the system can employ only analog beams. Due to the O2 absorption loss around 60 GHz frequency (˜10 dB additional loss @100 m distance), larger number of and sharper analog beams (hence larger number of radiators in the array) may be provided to compensate for the additional path loss.

In TDD, a common approach to acquire DL channel state information is to exploit UL channel estimation through receiving UL RSs (e.g., SRS) sent from UE. By using the channel reciprocity in TDD systems, the UL channel estimation itself can be used to infer DL channels. This favorable feature enables NW to reduce the training overhead significantly. Thus, in gNB, channel estimation (CE) may be critical for achieving high spectral efficiency and reliable cell coverage, as the estimated channel state information (CSI) is used for many operations.

There are two types of channel estimation: (1) SRS-based CE and (2) DMRS CE. SRS-based CE is implemented in the gNB, which relies on the sounding reference signal (SRS) to estimate the CSI in a time division duplex (TDD) system, and uses the CSI to perform scheduling and beamforming weight calculation. DMRS CE is used for uplink (UL) data reception, where the gNB obtains the CSI via demodulation reference signals (DMRS), and uses the CSI for equalization.

The CE typically comprises two stages of operation: (1) a noisy estimate is obtained by removing the reference signals (RS) and (2) the noisy estimate is refined before the noisy estimate can be used in subsequent modules or processing.

The refinement stage may be critical, and usually carefully designed algorithms are provided for the refinement stage. In conventional signal processing, the MMSE estimator is optimal in the sense of the mean square error (MSE). The MMSE estimator exploits the second order channel statistics such as the covariance and cross-correlation matrices, and SNR/noise power. However, these statistics are usually difficult to calculate, due to (1) the pilots/RS are transmitted sparsely in time and frequency domain; (2) the RS can display varying SNR due to power control and environment change; and (3) the channel can experience non-stationarity especially in a mobility scenario.

As a result, the MMSE is computationally expensive to deploy in commercial systems. Thus, good performance and low complexity CE algorithms are important for practical NR systems.

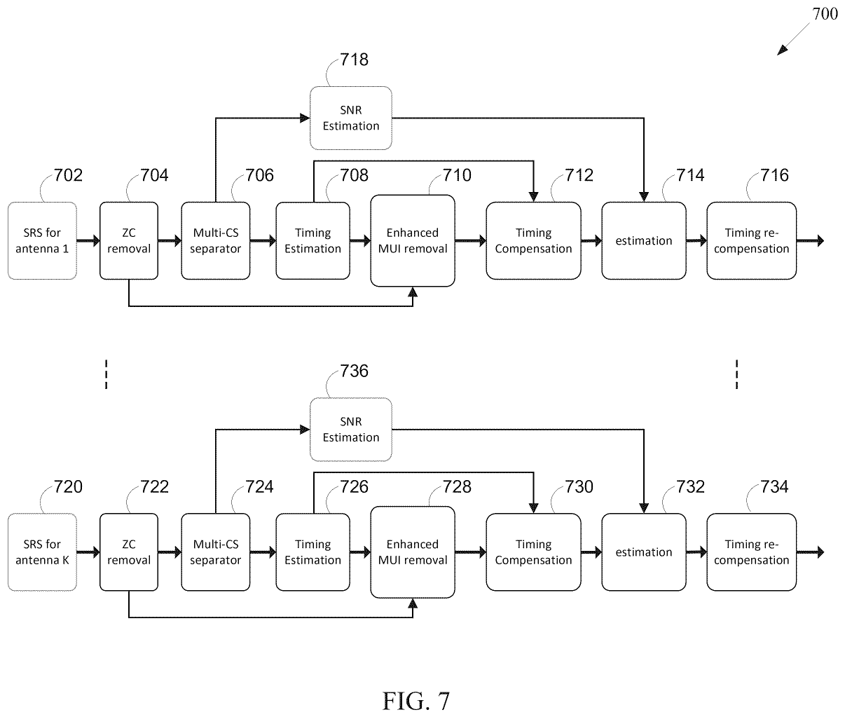

FIG. 7 illustrates the baseline CE algorithm, where each antenna is processed independently, with the multi-user interference removed, timing offset compensated, and a baseline estimation (for instance, moving average) applied.

FIG. 7 illustrates an example of channel estimation procedure 700 according to various embodiments of the present disclosure. The channel estimation procedure 700 as may be performed by a BS (e.g., 101-103 as illustrated in FIG. 1). An embodiment of the channel estimation procedure 700 shown in FIG. 7 is for illustration only. One or more of the components illustrated in FIG. 7 can be implemented in specialized circuitry configured to perform the noted functions or one or more of the components can be implemented by one or more processors executing instructions to perform the noted functions.

As illustrated in FIG. 7, the estimation procedures are performed via a number of SRSs for multiple antennas, for example antenna 1 to antenna k. The blocks 702 to 716 are applied for the SRS for the antenna 1 and the blocks 720 to 716 are applied for the SRS for the antenna k. Each of the blocks performs the same function for the antenna 1 and antenna k. In block 702, SRS is identified for an antenna 1. In block 704, ZC is removed. In block 706, multi-CS is separated by a separator. In block 708, timing estimation is performed. In block 710, enhanced MUI removal is performed. In block 712, a timing compensation is performed. In block 714, estimation is performed. In block 716, the timing is re-compensated. In block 718, the SNR estimation is performed after the block 706 (e.g., multi-CS separation). The output of the block 718 (e.g., the SNR estimation) is provided to the block 714 (e.g., estimation block).

As illustrated above, in block 720, SRS is identified for an antenna k. In block 722, ZC is removed. In block 724, multi-CS is separator by a separator. In block 726, timing estimation is performed. In block 728, enhanced MUI removal is performed. In block 730, a timing compensation is performed. In block 732, estimation is performed. In block 734, the timing is re-compensated. In block 736, the SNR estimation is performed after the block 724 (e.g., multi-CS separation). The output of the block 718 (e.g., the SNR estimation) is provided to the block 732 (e.g., estimation block).

In the present disclosure, a more advanced CE algorithm is provided to use the antennas for jointly estimate some features, and deploy an AI-assisted method to design and apply the estimation/filters to be applied.

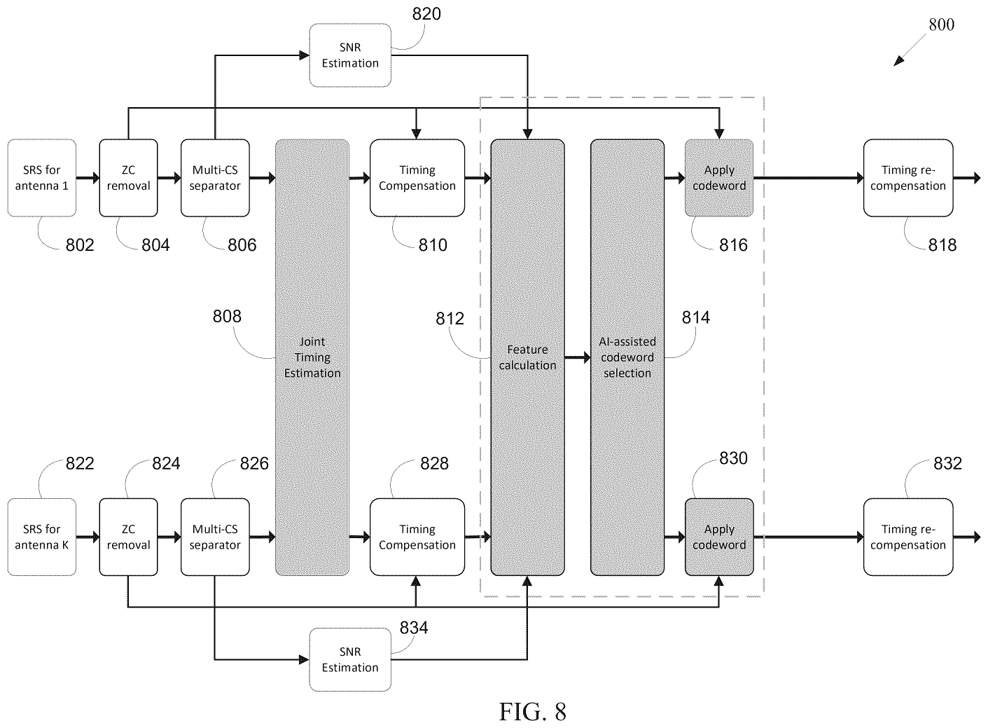

FIG. 8 illustrates an example of filter-based channel estimation procedure 800 according to various embodiments of the present disclosure. The filter-based channel estimation procedure 800 as may be performed by a BS (e.g., 101-103 as illustrated in FIG. 1). An embodiment of the filter-based channel estimation procedure 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

As illustrated in FIG. 8, the filter-based channel estimation procedures are performed via a number of SRSs for multiple antennas, for example antenna 1 to antenna k. The blocks 802 to 818 are applied for the SRS for the antenna 1 and the blocks 822 to 832 are applied for the SRS for the antenna k. Each of the blocks performs the same function for the antenna 1 and antenna k. In block 802, SRS is identified for an antenna 1. In block 804, ZC is removed. In block 806, multi-CS is separated by a separator. In block 808, joint timing estimation is performed for the SRS for the antenna 1 and the SRS for the antenna k. In block 810, timing compensation is performed. In block 812, a feature is calculated. In block 814, AI-based codeword selection is performed. In block 816, the codeword is applied. In block 818, timing compensation is performed. In step 820, the SNR estimation is performed after the block 806 (e.g., multi-CS separator). The output of the block 820 (e.g., the SNR estimation) is provided to the block 812 (e.g., feature calculation block). The output of block 804 (e.g., ZC removal) is provided to the block 810 (e.g., timing compensation) and the block 816 (e.g., apply codeword).

As illustrated above, in block 822, SRS is identified for an antenna k. In block 824, ZC is removed. In block 826, multi-CS is separated by a separator. In block 808, joint timing estimation is performed for the SRS for the antenna 1 and the SRS for the antenna k. In block 828, timing compensation is performed. In block 812, a feature is calculated. In block 814, AI-based codeword selection is performed. In block 830, the codeword is applied. In block 832, timing compensation is performed. In step 834, the SNR estimation is performed after the block 826 (e.g., multi-CS separator). The output of the block 834 (e.g., the SNR estimation) is provided to the block 828 (e.g., feature calculation block). The output of block 824 (e.g., ZC removal) is provided to the block 828 (e.g., timing compensation) and the block 830 (e.g., apply codeword).

In summary, the filter-based channel estimation procedures are in the following steps: (1) from received SRS or DMRS reference channels, the timing/frequency offset of the target and interfering UE channels, and the SNR is estimated; (2) from the system design (based on OCC/CS sequence), determine approximate the locations of the interference UEs in delay domain; (3) based on the target UE, a cyclic is provided to shift the target UE to be near 0 (or low delay bin regions) by timing compensation; (4) based on the location of UE (based on cyclic prefix equivalent delay bin), the filter design is provided in a delay equivalent domain, with the constraint filter length (in frequency domain); and (5) apply the filter in frequency domain to get the channel estimation.

The above AI-assisted structure shows performance improvement compared to the baseline.

To further improve the CE performance in the low SNR region, in the present disclosure, the antennas' spatial correlation is provided in addition to the frequency domain filtering. One example procedure is illustrated as below, where the spatial denoising module is added after the frequency domain estimation.

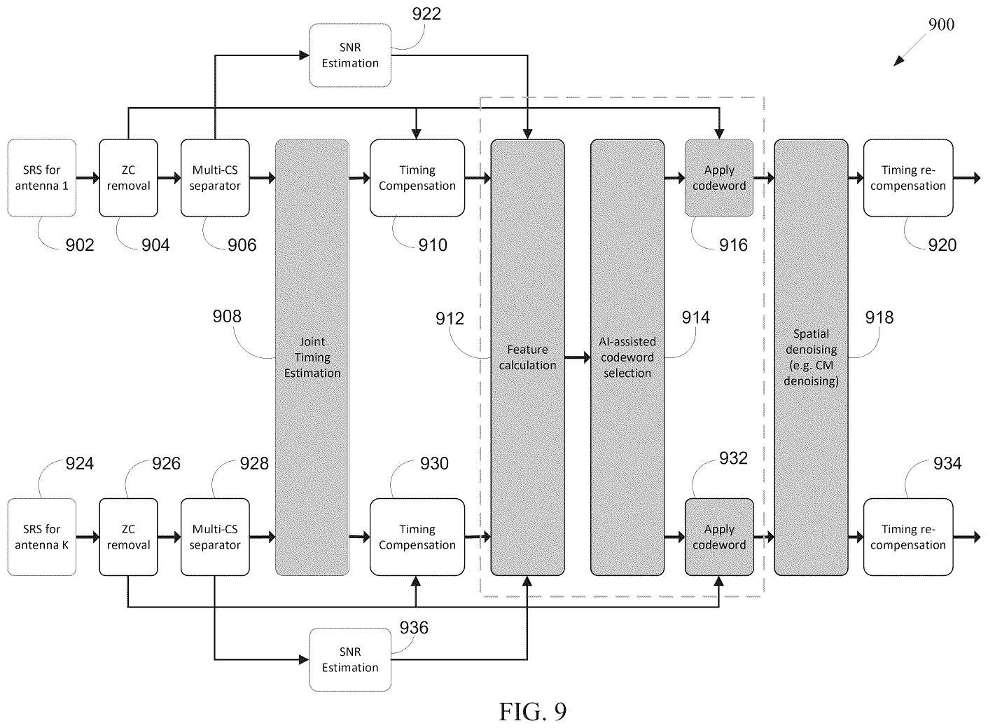

FIG. 9 illustrates an example of filter-based channel estimation procedure 900 according to various embodiments of the present disclosure. The filter-based channel estimation procedure 900 as may be performed by a BS (e.g., 101-103 as illustrated in FIG. 1). An embodiment of the filter-based channel estimation procedure 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions.

As illustrated in FIG. 9, the filter-based channel estimation procedures are performed via a number of SRSs for multiple antennas, for example antenna 1 to antenna k. The blocks 902 to 920 are applied for the SRS for the antenna 1 and the blocks 924 to 934 are applied for the SRS for the antenna k. Each of the blocks performs the same function for the antenna 1 and antenna k. In block 902, SRS is identified for an antenna 1. In block 904, ZC is removed. In block 906, multi-CS is separated by a separator. In block 908, joint timing estimation is performed for the SRS for the antenna 1 and the SRS for the antenna k. In block 910, timing compensation is performed. In block 912, a feature is calculated. In block 914, AI-based codeword selection is performed. In block 916, the codeword is applied. In block 918, spatial denoising is performed for the SRS for the antenna 1 and the SRS for the antenna k. In block 920, timing compensation is performed. In step 922, the SNR estimation is performed after the block 906 (e.g., multi-CS separator). The output of the block 922 (e.g., the SNR estimation) is provided to the block 912 (e.g., feature calculation block). The output of block 904 (e.g., ZC removal) is provided to the block 910 (e.g., timing compensation) and the block 916 (e.g., apply codeword).

As illustrated above, in block 924, SRS is identified for an antenna 1. In block 926, ZC is removed. In block 928, multi-CS is separated by a separator. In block 908, joint timing estimation is performed for the SRS for the antenna 1 and the SRS for the antenna k. In block 930, timing compensation is performed. In block 912, a feature is calculated. In block 914, AI-based codeword selection is performed. In block 932, the codeword is applied. In block 918, spatial denoising is performed for the SRS for the antenna 1 and the SRS for the antenna k. In block 934, timing compensation is performed. In step 936, the SNR estimation is performed after the block 928 (e.g., multi-CS separator). The output of the block 936 (e.g., the SNR estimation) is provided to the block 912 (e.g., feature calculation block). The output of block 926 (e.g., ZC removal) is provided to the block 930 (e.g., timing compensation) and the block 932 (e.g., apply codeword).

Spatial domain CE can comprise: (1) compress the channel into a lower-dimension/sparse domain (e.g., canonical model (CM), eigendirections); (2) SNR scaling (discarding) for different (spatial) kernels; and (3) bring back to original dimension.

In one embodiment, the channel sparsity in delay and spatial domain are provided. The channel can be projected onto different set of bases. The bases that capture the largest energy can be used as the compression coefficients. The example method for the projection is to use canonical model.

The spatial denoising can comprise: (1) a condition enabling step, (2) a determination of a number of beams step, (3) a construction of beam book step, (4) a bases selection step, (5) a bases denoising step, and (6) a channel reconstruction step. In such bases selection step, following procedures may be provided; (1) a step of reordering the antenna step, (2) a step of projecting the channel onto the bases, (3) a step of selecting beams according to best power.

In one embodiment for enabling a condition step, it is provided that the spatial denoising is only enabled for low SNR, by the predefined snr threshold, snrTh. If snrEst>=snrTh, the spatial denoising module is disabled. Otherwise, following procedures are operated, for example, snrTh=5 dB. The enabling threshold can change according to different cell environment.

In one embodiment for deciding a number of beams step, a number of beams to select, nBeam is decided according to the nBeamMap Tables. The nBeamMap table can be adaptive according to the deployed scenario. A few tables are reserved for switching online.

In one embodiment for constructing a beam book step, as an example of oversampled 2D DFT codebook, 2D DFT array of size [N₁, N₂] is constructed, with oversampling factor Os=[O₁, O₂], within predefined angle range. Horizontal DFT beam of size N₁, oversampling rate O₁, within AngleRange1. Denote the k-th codeword of c-th oversampled codebook as:

$${w}_{H , c} ( k ) = {e}^{j 2 π [ 0 : {N}_{1} - 1 ] * ( AngleRange 1 ( 1 ) + \frac{k - 1}{{N}_{1}} + \frac{( c - 1 )}{{cN}_{1}} )}$$

where c=1 . . . O₁.

Vertical DFT beam of size N₂, oversampling rate O₂, within AngleRange1. Denote the k-th codeword of c-th oversampled codebook as:

$${w}_{V , c} ( k ) = {e}^{j 2 π [ 0 : {N}_{2} - 1 ] * ( AngleRange 2 ( 1 ) + \frac{k - 1}{{N}_{2}} + \frac{( c - 1 )}{{cN}_{2}} )}$$

where c=1 . . . O₂.

The 2D DFT codebook is constructed as Kronecker product of the horizontal and vertical codebook:

$${w}_{V , {c}_{1} , {c}_{2}} ( {k}_{1} , {k}_{2} ) = {w}_{H , {c}_{1}}^{T} ( {k}_{1} ) ⊗ {w}_{V , {c}_{2}} ( {k}_{2} ) .$$

Given the parameters defined, there are O₁*O₂ groups of DFT bases defined, and each group of bases contain N₁*N₂ 2D DFT codewords.

In one embodiment for selecting bases step, for notation simplicity, each codeword is vectorized and the k-th (k=1,2, . . . N₁N₂) codeword in o-th (o=1, 2, . . . O₁O₂) group is denoted as bₒ(k). Each group of DFT bases is denoted as Bₒ=[bₒ(1), bₒ(2), . . . bₒ(N₁N₂)]

The best nBeams of one group are selected in below described procedure.

In one embodiment for re-ordering the antenna step, the antennas may be re-ordered following the arrangement of codeword construction, i.e., Ordering of antenna index, assuming horizontally labeled, and finish one pol first, the channel separating the two polarizations is arranged:

$${H}_{{N}_{R} \times {N}_{f}} = [ \begin{matrix}{H}_{pol 1 , [ {N}_{1} {N}_{2} , \times {N}_{f} ]} \\ {H}_{pol 2 , [ {N}_{1} {N}_{2} \times {N}_{f} ]}\end{matrix} ] .$$

In one embodiment for projecting the channel onto bases, for each bases group Bₒ, the channel is projected on it, and projected coefficients G^{o} is obtained as:

$${G}^{o} = [ \begin{matrix}{B}_{o}^{H} & 0 \\ 0 & {B}_{o}^{H}\end{matrix} ] [ \begin{matrix}{H}_{pol 1 , [ {N}_{1} {N}_{2} , \times {N}_{f} ]} \\ {H}_{pol 2 , [ {N}_{1} {N}_{2} \times {N}_{f} ]}\end{matrix} ] = [ \begin{matrix}{G}_{pol 1 , [ {N}_{1} {N}_{2} , \times {N}_{f} ]}^{o} \\ {G}_{pol 2 , [ {N}_{1} {N}_{2} \times {N}_{f} ]}^{o}\end{matrix} ] .$$

$${G}_{pol 1}^{0} ( k , n )$$

is denoted as the projected coefficient on the k-th beam, and n-th RE.

In one embodiment for selecting beams according to beset power, the sum power of the k-th beam in o-th group over freq. is computed as:

$${p}_{0} ( k ) = {\sum }_{n} ( {\vert {G}_{p o l 1}^{o} ( k , n ) \vert}^{2} + {\vert {G}_{p o l 2}^{o} ( k , n ) \vert}^{2} ) .$$

For each group o of DFT bases, sort the beams according to descending power, and computes the best nBeam beams power: Pₒ=Σ_{k=1 . . . nBeam}pᵢ(k).

The selected group (s) has the largest power, and the best nBeam beams are selected and retained. Denote the set of selected beam index as β.

In one embodiment for bases denoising step, the projected coefficients of the selected bases is denoted as G^{s}. The unused beam is discarded by setting the corresponding coefficients to 0, i.e.:

$${\tilde{G}}^{s} ( k , n ) = \{ \begin{matrix}{G}^{S} ( k , n ) , if k ∈ β \\ 0 , otherwise\end{matrix} .$$

The non-zero \tilde{G}^{s}(k, n) is further multiplied by a scaling factor.

The scaling factor is computed as

$$\frac{{p}^{s} ( k ) - {\hat{σ}}_{e s t}^{2} * n Var ScaleSpt}{{p}^{s} ( k )} ,$$

where

$${\hat{σ}}_{est}^{2}$$

is averaged noise estimation over all available antennas and SBs.

nVarScaleSpt is a design parameter to control how much noise may be removed from the estimated power to mimic the signal.

When the selected bases set is common across different time slots, the projected power is IIR filtered, i.e., if s_{g}==s_{g,previous}, p^{s}(k)=αp^{s}(k)_{current}+(1−α)p^{s}(k)ₚᵣₑᵥᵢₒᵤₛ.

In one embodiment for reconstructing the channel, the channel is reconstructed using selected/denoised kernels:

$$\hat{H} = [ \begin{matrix}{B}_{s} & 0 \\ 0 & {B}_{s}\end{matrix} ] {\tilde{G}}^{S} .$$

In the present disclosure, following embodiments and/or examples are provided: (1) utilizing one or more antennas' spatial correlations, in addition to frequency domain filtering, to perform spatial domain channel estimation; and/or (2) compressing a channel into a lower-dimension domain or a sparse domain, performing signal-to-noise ratio (SNR) scaling for different kernels, and bringing the channel back to the original dimension.

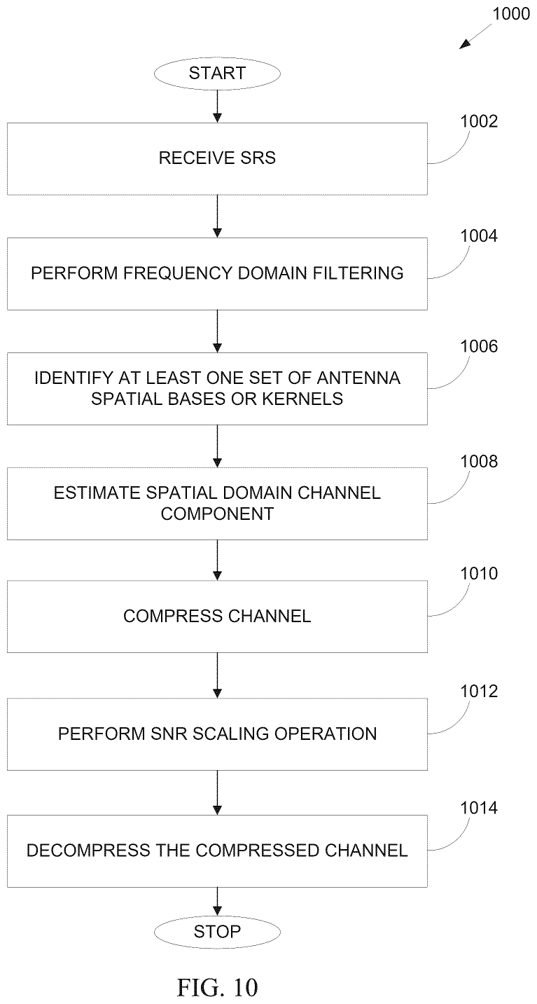

FIG. 10 illustrates a flowchart of BS method 1000 for a spatial denoising in AI-assisted channel estimation according to various embodiments of the present disclosure. The BS method 1000 as may be performed by a UE (e.g., 111-116 as illustrated in FIG. 1). An embodiment of the BS method 1000 shown in FIG. 10 is for illustration only. One or more of the components illustrated in FIG. 10 can be implemented in specialized circuitry configured to perform the noted functions or one or more of the components can be implemented by one or more processors executing instructions to perform the noted functions.

As illustrated in FIG. 0, the MS method 1000 begins at step 1002. In step 1002, a BS receives, from a (UE, an SRS for a channel estimation operation.

Subsequently, in step 1004, the BS performs, based on the SRS, a frequency domain filtering operation.

Subsequently, in step 1006, the BS identifies, based on the frequency domain filtering operation, at least one set of antenna spatial bases or kernels.

Next, in step 1008, the BS estimates, based on the at least one set of the antenna spatial bases, a spatial domain channel component.

Next, in step 1010, the BS compresses, based on the estimated spatial domain channel component, a channel into a low-dimension domain or a sparse domain, wherein the channel is identified in a dimension.

Next, in step 1012, the BS performs, based on the compressed channel, an SNR scaling operation for different kernels in the at least one set of kernels.

Finally, in step 1014, the BS decompresses, based on the SNR scaling operation, the compressed channel into the dimension for the channel estimation operation.

In one embodiment, the BS performs a spatial denoising operation after performing the frequency domain filtering operation.

In one embodiment, the BS enables, based on a predefined threshold, the spatial denoising operation, wherein the predefined threshold is identified based on a cell configuration.

In one embodiment, the BS disables the spatial denoising operation when an estimated threshold is greater than the predefined threshold.

In one embodiment, the BS identifies, based on predefined values, a number of beams for performing the spatial denoising operation.

In such embodiments, the at least one set of antenna spatial bases or kernels is used to denoise the channel in a SNR region including a lower SNR than other channels in the SNR region.

In one embodiment, the BS scales a kernel coefficient and removes the at least one set of kernels, in a SNR region including a lower SNR than other kernels in the SNR region, to project channel into the at least one set of antenna spatial bases or kernels.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A base station (BS) in a wireless communication system, the BS comprising:
a transceiver configured to receive, from a user equipment (UE), a sounding reference signal (SRS) for a channel estimation operation; and
a processor operably couped to the transceiver, the processor configured to:
perform, based on the SRS, a frequency domain filtering operation,
identify, based on the frequency domain filtering operation, at least one set of antenna spatial bases or kernels,
estimate, based on the at least one set of the antenna spatial bases, a spatial domain channel component,
compress, based on the estimated spatial domain channel component, a channel into a low-dimension domain or a sparse domain, wherein the channel is identified in a dimension,
perform, based on the compressed channel, a signal-to-noise ratio (SNR) scaling operation for different kernels in the at least one set of kernels, and
decompress, based on the SNR scaling operation, the compressed channel into the dimension for the channel estimation operation.

2. The BS of claim 1, wherein the processor is further configured to perform a spatial denoising operation after performing the frequency domain filtering operation.

3. The BS of claim 2, wherein the processor is further configured to enable, based on a predefined threshold, the spatial denoising operation, and
wherein the predefined threshold is identified based on a cell configuration.

4. The BS of claim 3, wherein the processor is further configured to disable the spatial denoising operation when an estimated threshold is greater than the predefined threshold.

5. The BS of claim 2, wherein the processor is further configured to identify, based on predefined values, a number of beams for performing the spatial denoising operation.

6. The BS of claim 1, wherein the at least one set of antenna spatial bases or kernels is used to denoise the channel in a SNR region including a lower SNR than other channels in the SNR region.

7. The BS of claim 1, wherein the processor is further configured to:
scale a kernel coefficient; and
remove the at least one set of kernels, in a SNR region including a lower SNR than other kernels in the SNR region, to project channel into the at least one set of antenna spatial bases or kernels.

8. A method of a base station (BS) in a wireless communication system, the method comprising:
receiving, from a user equipment (UE), a sounding reference signal (SRS) for a channel estimation operation;
performing, based on the SRS, a frequency domain filtering operation;
identifying, based on the frequency domain filtering operation, at least one set of antenna spatial bases or kernels;
estimating, based on the at least one set of the antenna spatial bases, a spatial domain channel component;
compressing, based on the estimated spatial domain channel component, a channel into a low-dimension domain or a sparse domain, wherein the channel is identified in a dimension;
performing, based on the compressed channel, a signal-to-noise ratio (SNR) scaling operation for different kernels in the at least one set of kernels; and
decompressing, based on the SNR scaling operation, the compressed channel into the dimension for the channel estimation operation.

9. The method of claim 8, further comprising performing a spatial denoising operation after performing the frequency domain filtering operation.

10. The method of claim 9, further comprising enabling, based on a predefined threshold, the spatial denoising operation, wherein the predefined threshold is identified based on a cell configuration.

11. The method of claim 10, further comprising disabling the spatial denoising operation when an estimated threshold is greater than the predefined threshold.

12. The method of claim 9, further comprising identifying, based on predefined values, a number of beams for performing the spatial denoising operation.

13. The method of claim 8, wherein the at least one set of antenna spatial bases or kernels is used to denoise the channel in a SNR region including a lower SNR than other channels in the SNR region.

14. The method of claim 8, further comprising:
scaling a kernel coefficient; and
removing the at least one set of kernels, in a SNR region including a lower SNR than other kernels in the SNR region, to project channel into the at least one set of antenna spatial bases or kernels.

15. A non-transitory computer-readable medium comprising program code, that when executed by at least one processor, causes an electronic device to:
receive, from a user equipment (UE), a sounding reference signal (SRS) for a channel estimation operation;
perform, based on the SRS, a frequency domain filtering operation;
identify, based on the frequency domain filtering operation, at least one set of antenna spatial bases or kernels;
estimate, based on the at least one set of the antenna spatial bases, a spatial domain channel component;
compress, based on the estimated spatial domain channel component, a channel into a low-dimension domain or a sparse domain, wherein the channel is identified in a dimension;
perform, based on the compressed channel, a signal-to-noise ratio (SNR) scaling operation for different kernels in the at least one set of kernels; and
decompress, based on the SNR scaling operation, the compressed channel into the dimension for the channel estimation operation.

16. The non-transitory computer-readable medium of claim 15, further comprising program code, that when executed by at least one processor, causes an electronic device to perform a spatial denoising operation after performing the frequency domain filtering operation.

17. The non-transitory computer-readable medium of claim 16, further comprising program code, that when executed by at least one processor, causes an electronic device to enable, based on a predefined threshold, the spatial denoising operation, wherein the predefined threshold is identified based on a cell configuration.

18. The non-transitory computer-readable medium of claim 17, further comprising program code, that when executed by at least one processor, causes an electronic device to:
disable the spatial denoising operation when an estimated threshold is greater than the predefined threshold; and
identify, based on predefined values, a number of beams for performing the spatial denoising operation.

19. The non-transitory computer-readable medium of claim 15, wherein the at least one set of antenna spatial bases or kernels is used to denoise the channel in a SNR region including a lower SNR than other channels in the SNR region.

20. The non-transitory computer-readable medium of claim 15, further comprising program code, that when executed by at least one processor, causes an electronic device to:
scale a kernel coefficient; and
remove the at least one set of kernels, in a SNR region including a lower SNR than other kernels in the SNR region, to project channel into the at least one set of antenna spatial bases or kernels.
